(19) United States
(12) Patent Application Publication
(10) Pub. No.: US 2009/0137153 A1
(43) Pub. Date: May 28, 2009

(54) ELECTROMAGNETIC WAVE SHIELD CONNECTOR

(75) Inventors: Nobuaki YOSHIOKA, Makinohara-shi (JP); Masahiro DENO, Makinohara-shi (JP)

Correspondence Address: SUGHRUE-265550, 2100 PENNSYLVANIA AVE. NW, WASHINGTON, DC, 20037-3213, US

(73) Assignee: YAZAKI CORPORATION, Tokyo (JP)

(21) Appl. No.: 12/242,968

(22) Filed: Oct. 1, 2008

(30) Foreign Application Priority Data
Nov. 27, 2007 (JP) 2007-305695

(51) Int. Cl. H01R 13/648

(52) U.S. Cl. 439/607.24

(57) ABSTRACT

The invention provides an electromagnetic wave shield connector assuring water resistance without increasing the overall height. An electromagnetic wave shield connector including a L-shaped terminal with an electric wire including a electric connection part and a wire connection part, an inner housing including a first storing part in which the first storing part is inserted, and a second storing part in which the second storing part is accommodated an outer housing accommodating the first storing part, and a shield member-covering the outer housing assembled with the inner housing. The first storing part having a through-part into which the first storing part is inserted and a first gasket mounted on a periphery of the first storing part. The first storing part is cylinder shaped. The outer housing having an opening whose inner periphery comes by intimate contact with the first gasket.

### BACKGROUND

The present invention relates to an electromagnetic wave shield connector accommodating a terminal with electric wire.

An example of an electromagnetic wave shield connector is shown in FIGS. 9 and 10. An electromagnetic wave shield connector 100 includes a connector housing 104 and a gasket 108. The connector housing has a shield shell 103 and L-shaped terminal 102 connected to a wire terminal 101. In this example, the L-shaped terminal 102 and the shield shell 103 are integrally formed by resin molding process. The gasket 108 is mounted between the opening 106 of a counterpart device 105 and the fitting part 107 of the connector housing 104 (for example, FIG. 6, refer to Patent Reference JP-A-2005-235424).

Typically, in an an electromagnetic wave shield connector, a wire terminal is arranged in a direction perpendicular to a connector housing. In this case, the length of a bent portion of a wire may be added to a height dimension thus increasing the overall height dimension in sidewise routing of the wire. At this point, the electromagnetic wave shield connector 100 disclosed in JP-A-2005-235424 is designed to reduce the height dimension. In this example, however, the electromagnetic wave shield connector 100 is integrally molded with the wire terminal 101 so that the entirety of the connector housing 104 is wagged when the wire terminal 101 is pulled sideways. This fact can impair water proof since adhesion of the gasket 108 to the opening 106 in the counterpart device 105 is reduced.

### BRIEF SUMMARY

The invention has been accomplished in view of the aforementioned problems. An object of the invention is to provide an electromagnetic wave shield connector that assures water proof without increasing the overall height.

The object of the invention is attained by the following configurations.

The configuration of the present invention is an electromagnetic wave shield connector including an L-shaped terminal for connecting an electric wire having an electric connection part for connecting a counterpart connector and a wire connection part, an inner housing including a first storing part in which the electric connection part is inserted and a second storing part in which the wire connection part is accommodated, an outer, housing accommodating the first storing part, a shield member covering the outer housing assembled with the inner housing, and a first elastic member mounted on the first storing part so as to come into contact with the first storing portion and the outer housing.

Preferably, the electromagnetic wave shield connector according to claim 1, wherein the first storing part has cylindrical shaped.

Preferably, the outer housing of the electromagnetic wave shield connector has a plurality of openings for accommodating a plurality of the inner housing respectively.

Preferably, the electromagnetic wave shield connector has a second elastic member provided between the counterpart connector and the outer housing.

Preferably, the electric connection part and the wire connection part are embedded by resin.

Preferably, the electromagnetic wave shield connector has a rubber plug provided with the wire. The rubber plug is assembled with the inner housing through the shield member. The electric wire is connected to the wire connection part.

According to above, the inner housing accommodating the L-shaped terminal with the electric wire and an outer housing accommodating the inner housing form a double structure and the first gasket mounted on the first storing part of the inner housing is in intimate contact with the opening in the outer housing. This allows the electric connection part to rotate slightly in the first storing part so as to maintain intimate contact even when the wire of the terminal is pulled sideway. Therefore, the outer housing is never wagged and this configuration ensures water proof without increasing the overall height.

In addition to above mentioned advantage, vibrations of a vehicle or a device that may be connected to the terminal with the electric wire is attenuated by the first gasket. This enhances the reliability of electric connection between a terminal with electric wire and a counterpart terminal and ensures water proof between an inner housing and an outer housing.

Besides, the inner housing or outer housing has a cylindrical shape. This minimizes the shrinkage of the first gasket under self-alignment of the terminal with electric wire or when tension is applied to the wire.

And also, the outer housing is covered with a shield member so as to provide electromagnetic shielding.

Preferably, a plurality of inner housings accommodating terminals with electric wires is individually and independently accommodated in a plurality of openings in the outer housing. In this configuration, because a stress caused by pulling or vibrations of wire is absorbed individually, this configuration assures water proof.

In addition to the first gasket mounted on the first storing part of the inner housing is in intimate contact with the opening of the outer housing, the second gasket is mounted between the outer housing and the counterpart connector accommodating the counterpart terminal. This prevents, for example, possible leakage of lubricating oil or cooling oil filled in an oil-cooled motor when the electromagnetic wave shielding connector is mounted onto the motor part having an oil-cooling structure.

The first storing part of the inner housing and the second storing part of the inner housing are insert-molded so as to cover the electric connection part and the wire connection part with resin. This eliminates the need for filling a filler or the like, which eliminates the man-hour necessary to fill a filler.

In the electromagnetic wave shield connector, a rubber plug is assembled to the wire via a shield member. For example, in case a coaxial wire with shield braided wire is used as the wire, it is possible to attain water proof of the wire, shield member, and inner housing.

The invention provides the electromagnetic wave shield connector assuring water resistance without increasing the overall height.

### BRIEF DESCRIPTION OF DRAWINGS

FIG. 1 is an exploded perspective view of an electromagnetic wave shield connector according to the first embodiment of the invention.

FIG. 2 is an external perspective view of the electromagnetic wave shield connector shown in FIG. 1 in an assembled state.

FIG. 3 is an external perspective view of the electromagnetic wave shield connector shown in FIG. 2 with top side down.

FIG. 4 is a cross-sectional view of the electromagnetic wave shield connector taken along line A-A in FIG. 2.

FIG. 5 is an external perspective view of an electromagnetic wave shield connector according to the second embodiment of the invention in an assembled state.

FIG. 6 is an external perspective view of the electromagnetic wave shield connector shown in FIG. 5 with top side down.

FIG. 7 is a cross-sectional view of the electromagnetic wave shield connector taken along line B-B in FIG. 5.

FIG. 8 is a partial exploded perspective view of the electromagnetic wave shield connector shown in FIG. 5.

FIG. 9 is a cross-sectional view or a related art electromagnetic wave shield connector.

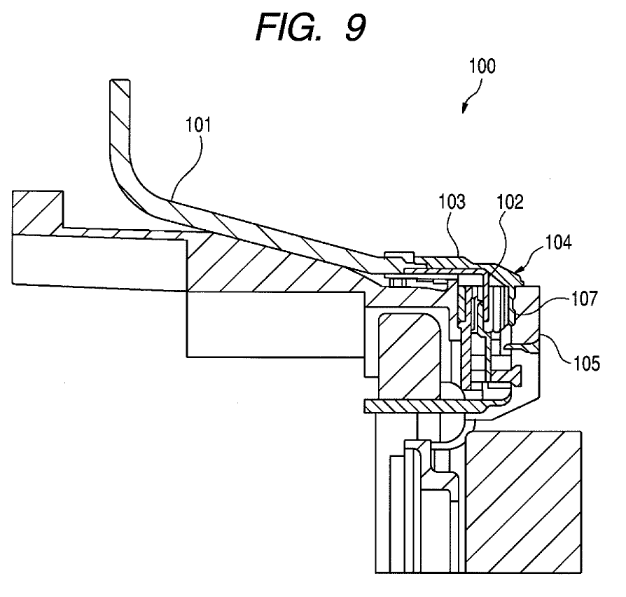

FIG. 10 is a partial enlarged view of the electromagnetic wave shield connector shown in FIG. 9.

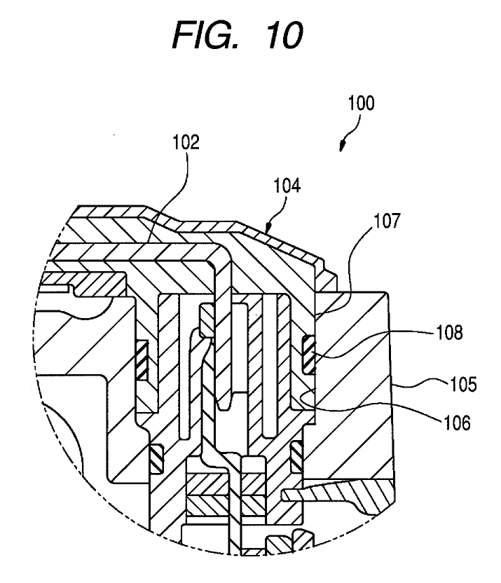

### DETAIL DESCRIPTION OF PREFERRED EMBODIMENTS

In followings, a plurality of preferable embodiments of the invention will be explained in detail based on drawings.

### First Embodiment

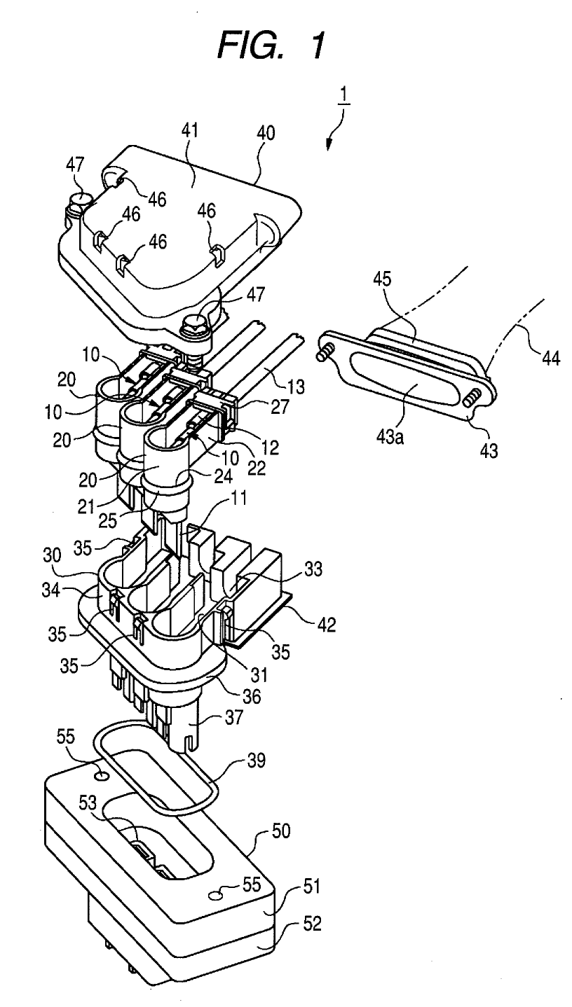

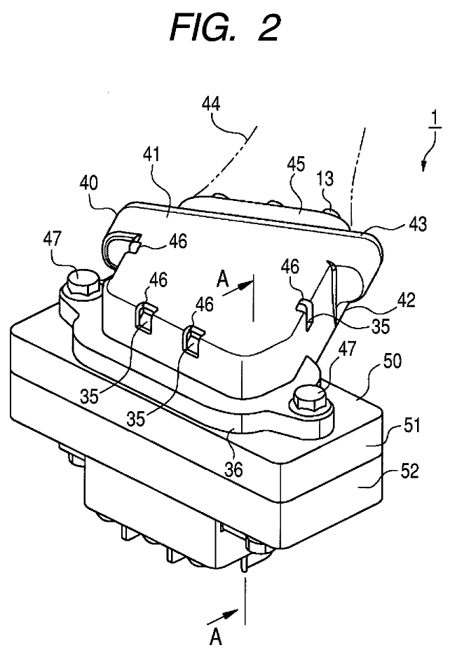

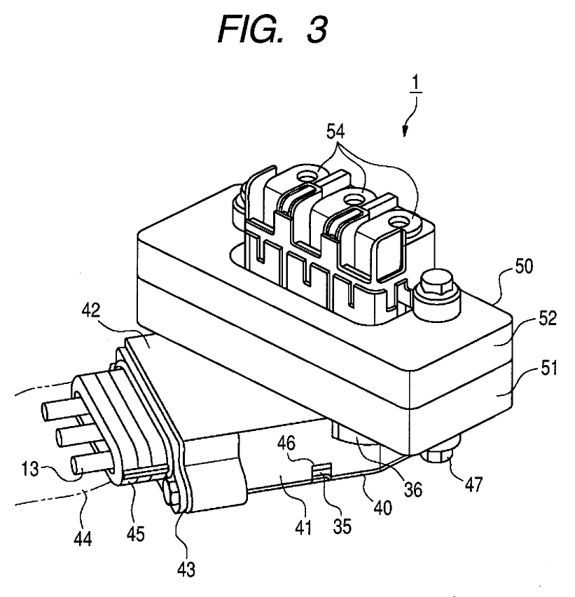

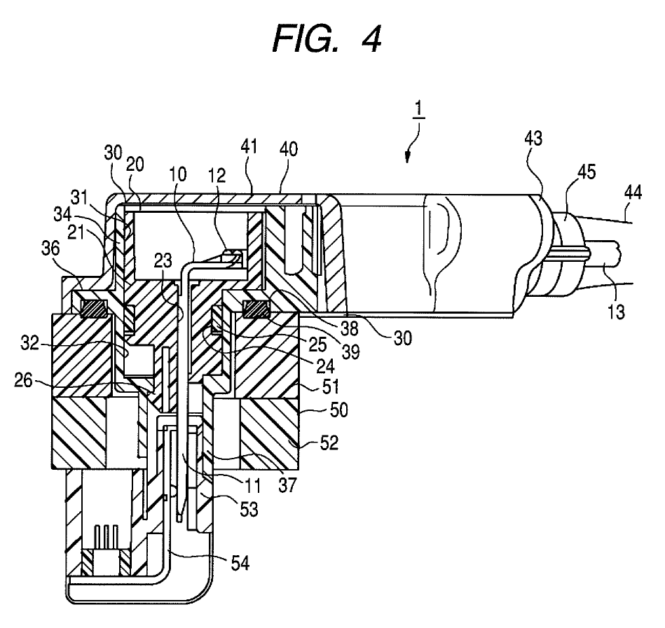

FIGS. 1 to 4 show an electromagnetic wave shield connector according to the first embodiment of the invention. FIG. 1 is an exploded perspective view of an electromagnetic wave shield connector according to the first embodiment of the invention. FIG. 2 is an external perspective view of the electromagnetic wave shield connector shown in FIG. 1 in an assembled state. FIG. 3 is an external perspective view of the electromagnetic wave shield connector shown in FIG. 2 with top side down. FIG. 4 is a cross-sectional view of the electromagnetic wave shield connector taken along line A-A in FIG. 2.

As shown in FIG. 1, an electromagnetic wave shield connector 1 according to the first embodiment of the invention mainly includes three terminals 10 with electric wire, three independent inner housings 20, an outer housing 30, and a shield member 40. The electromagnetic wave shield connector is connected to a counterpart connector 50.

The terminal 10 includes an electric connection part 11 at the tip. A wire connection part 12 is bent in a L-shape and extended from the electric connection part 11. The wire connection part 12 is electrically connected to a conductor (not shown) of the terminal of a wire 13.

The inner housing 20 is formed of an insulative resin. The inner housing 20 includes a cylindrical first storing part 21 and a second storing part 22 which bends and extends from the first storing part 21.

The first storing part 21 includes, on its inner periphery, a through-part (shown in FIG. 4) 23 into which the electric connection part 11 of the terminal 10 with electric wire is inserted. Also a first gasket 25 is mounted on the gasket mounting part 24. The gasket mounting part 24 is formed on outer periphery of the first storing part 21. The first storing part 21 has an inner housing side elastic locking piece (shown in FIG. 4) 26 formed below the first gasket 25 as shown in FIG. 1. The first gasket 25 is formed of an acrylic rubber into a ring shape.

The second storing part 22 accommodates the wire connection part 12 of the terminal 10 with electrical wire and has a wire support member 27 assembled to the leading-out end of the wire 13.

The inner housing 20 has the through-part 23 at the first storing part 21. The electric connection part 11 is inserted into the through-part 23. And also the wire connection part 12 is accommodated in the first storing part 22. By this assembling, the electric connection part 11 protrudes in the downward direction in FIG. 1 from the bottom of the first storing part 21. Preferably, the first storing part 21 and the second storing part 22 are insert-molded so that the electric connection part 11 and the wire connection part 12 will be covered with resin.

Same as the inner housing 20, the outer housing 30 is formed of an insulating resin. The outer housing 30 includes in parallel three inner housing storing parts 31 storing total three inner housings 20.

The inner housing storing part 31 includes an opening (shown in FIG. 4) 32 into which the first storing part 21 of the inner housing 20 is inserted. Also, the inner housing storing part 31 includes a wire guide 33 having a recessed groove shape similar to the external shape of the wire 13 at the leading-out end of the wire 13 of the terminal 10 stored in the inner housing 20.

The outer housing 30 has outer housing side elastic locking pieces 35 respectively in four positions of an outer wall 34 forming an inner housing storing part 31. From a flange part 36 arranged at the bottom of the inner housing storing part 31, cylindrical hood parts 37 are extended in the downward direction in FIG. 1. The number of these cylindrical hood parts 37 is same as that of inner housing storing part 31. Besides, these cylindrical hood parts 37 are communicated to the interior sections of the inner housing storing parts 31 respectably.

The outer housing 30 has a ring-shaped gasket mounting part (shown in FIG. 4) 38 formed on the lower surface of the flange part 36. On this gasket mounting part 38, a second gasket 39 is mounted. Same as the first gasket 25, the second gasket 39 is formed of an acrylic rubber into a ring shape.

The shield member 40 is formed of a conductive metal and is mainly made of a shield shell body 41 is attached to the upper portion of the outer housing 30. The shield member 40 includes a shield shell cover 42 which is attached to the lower part of the outer housing 30. A shield plate 43 is screwed into the shield shell body 41 and a shield ring 45 is provided to the shield plate 43 via a braided conductor 44. These components are electrically connected to the shield body 41 through this assembling.

The shield shell 41 is formed enough larger than the external shape of the outer housing 30 and into a shape covering the outer housing 30. The shield shell 41 has, on the lateral side thereof, engaging holes 46 respectively formed in the same positions as the outer housing side elastic locking pieces 35 of the outer housing 30. Further, two bolts 47 for mounting onto counterpart connectors 50 are inserted into the shield shell 41.

The counterpart connector 50 has a terminal cavity 53 formed below a first body 51 and a second body 52 forming cylinders. Inside the terminal cavity 53, three counterpart terminals (shown in FIG. 3) 54 are accommodated. The counterpart connectors 50 are mounted for example on a motor having an oil-cooling structure.

As shown in FIGS. 2 and 3, in the first step of the procedure for assembling the electromagnetic wave shield connector 1, the electric connection part 11 is inserted into the through-part 23 of the first storing part 21 of the inner housing 20. Then the wire connection part 12 of the terminal 10 with electric wire is stored in the second storing part 22 and the wire support member 27 is assembled thereto.

Next the inner housing 20 accommodating the terminal 10 is mounted on the inner housing storing part 31 of the outer housing 30. Then the electric connection part 11 is arranged into the hood part 37 of the outer housing 30. At this time the inner housing side elastic locking piece 26 is retained at a fixed position by the outer housing 30. Through this, the wire 13 is supported by the wire guide 33.

From upper-side of the outer housing 30, the shield shell body 41 is attached to the outer housing 30 to which the shield shell cover 42 is attached. At this time, the outer housing side elastic locking pieces 35 of the outer housing 30 are engaged with the engaging holes 46 in the shield shell body 41 respectively. The wire 13 is inserted into the braided conductor 44 via the shield plate 43. The shield ring 45 is assembled to the shield plate 43 with the braided conductor 44 sandwiched between the shield ring 45 and the shield ring mounting part 43a of the shield plate 43. The shield plate 43 is then screwed into the shield shell body 41.

Next, the bolt 47 of the shield shell body 41 is screwed into a threaded hole 55 formed in the first body 51 of the counterpart connector 50. Then the electromagnetic wave shield connector 1 is assembled to the counterpart connector 50 and electrically connects the electric connection part 11 to the counterpart terminal 54.

As shown in FIG. 4, in the electromagnetic wave shield connector 1 assembled to the counterpart connector 50, the first gasket 25 in the first storing part 21 of the inner housing 20 is in intimate contact with the inner surface of the opening 32 in the outer housing 30. And also, the second gasket 39 in the flange part 36 of the outer housing 30 is in intimate contact with the upper surface of the first body 51 of the counterpart connector 50. Even in case the wire 13 of the terminal 10 is pulled sideways, the pulling force is applied to the inner housing 20 alone, not to the outer housing 30.

Even when the counterpart connector 50 is mounted on an oil-cooled motor, the liquid tightness between the outer housing 30 and the first body 51 of the counterpart connector 50 is maintained by the second gasket 39. And also the liquid tightness between the outer housing 30 and the inner housing 20 is maintained by the first gasket 25. Thus, lubricating oil or cooling oil filled in an oil-cooled motor does not enter the electromagnetic wave shield connector 1.

As described above, according to the electromagnetic wave shield connector 1 of the first embodiment, the inner housing 20 accommodating an L-shaped terminal 10 with electric wire and the outer housing 30 accommodating the inner housing 20 form a double structure. Then the first gasket 25 mounted on the first storing part 21 of the inner housing 20 is in intimate contact with the opening 32 in the outer housing 30. Thus, even in case the wire 13 of the terminal 10 with electric wire is pulled sideways, the electric connection part 11 slightly rotates in the first storing part 21 without the outer housing 30 being wagged. This ensures water resistance without increasing the overall height.

Vibrations of a vehicle or a device connected to the terminal 10 with electric wire are attenuated by the first gasket 25. This enhances the reliability of electric connection of the terminal 10 to the counterpart terminal 54 and ensures water resistance between the inner housing 20 and the outer housing 30. And also, each of the inner housing 20 and outer housing 30 has a cylindrical shape. Therefore, the inner housing 20 slightly rotates in the outer housing 30 upon self-alignment of the terminal 10. Also, even when tension is applied to the wire 13, the inner housing 20 slightly rates in the outer housing 30. Then the shrinkage of the first gasket 25 is minimized. Finally, the outer housing 30 to which the inner housing 20 is assembled is covered with the shield member 41 to provide electromagnetic shielding.

According to the electromagnetic wave shield connector 1, three, inner housings 20 accommodating the terminals 10 are individually and independently accommodated in three openings 32 in the outer housing 30. Each set of these inner housing 20 and outer housing 30 individually absorbs a stress caused by pulling or vibrations of the wire 13, thereby assuring water proof.

According to the electromagnetic wave shield connector 1, the first gasket 25 mounted on the first storing part 21 of the inner housing 20 is in intimate contact with the opening 32 in the outer housing 30. In addition, the second gasket 39 is mounted between the outer housing 30 and the counterpart connector 50 accommodating the counterpart terminal 54. This prevents possible entry of lubricating oil or cooling oil filled in an oil-cooled motor into the electromagnetic wave shield connector 1 for example in the procedure for mounting onto the motor part having an oil-cooling structure.

According to the electromagnetic wave shield connector 1, the first storing part 21 of the inner housing 20 accommodates the electric connection part 11 and the second storing part 22 of the inner housing 20 accommodates the wire connection part 12 of the terminal 10. The first and second storing parts are insert-molded so as to coat the electric connection part 11 and the wire connection part 12 with resin. This eliminates the need for filling a filler or the like, which eliminates the man-hours necessary to fill a filler.

### Second Embodiment

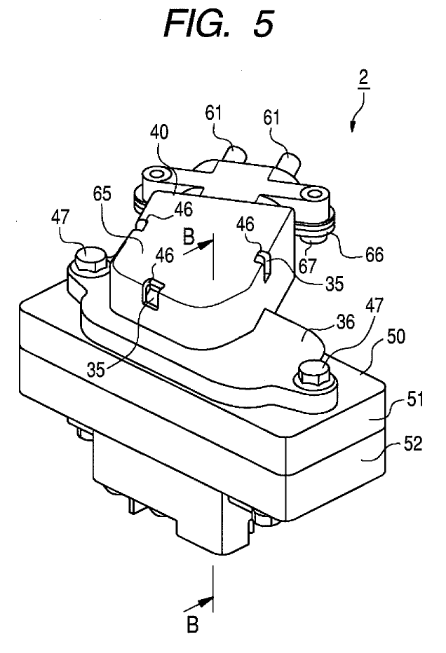

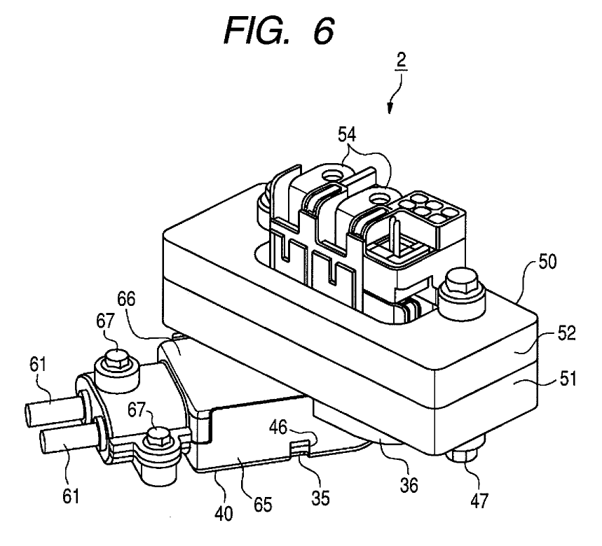

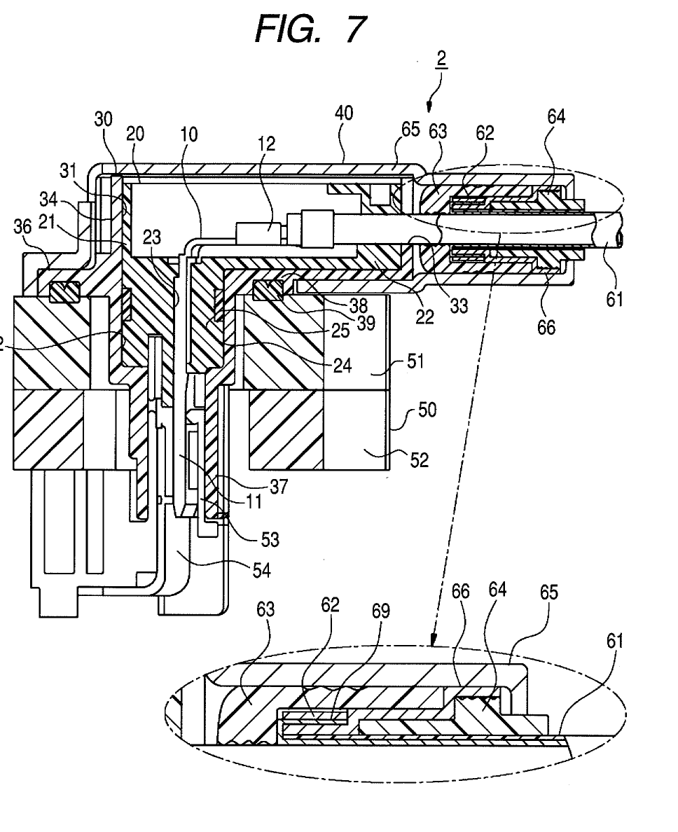

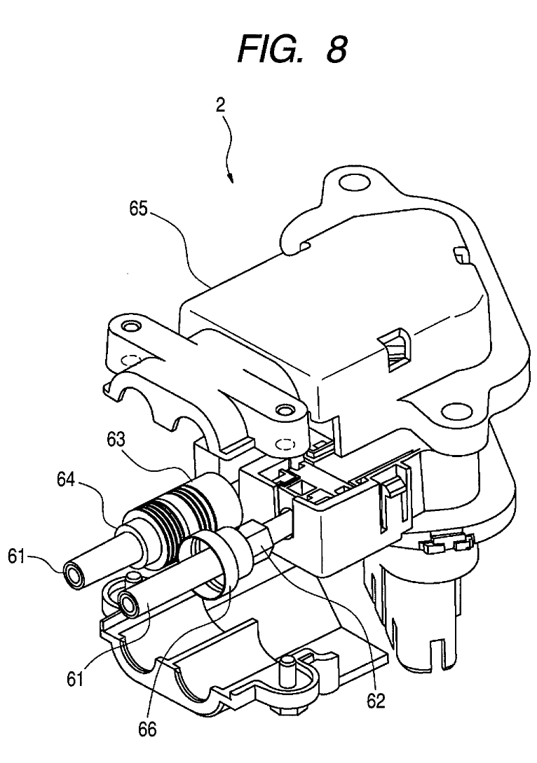

An electromagnetic wave shield connector according to the second embodiment of the invention will be described referring to FIGS. 5 to 8. FIGS. 5 to 8 show an electromagnetic wave shield connector according to the second embodiment of the invention. FIG. 5 is an external perspective view of an electromagnetic wave shield connector according to the second embodiment of the invention in an assembled state. FIG. 6 is an external perspective view of the electromagnetic wave shield connector shown in FIG. 5 with top side down. FIG. 7 is a cross-sectional view of the electromagnetic wave shield connector taken along line B-B in FIG. 5. FIG. 8 is a partial exploded perspective view of the electromagnetic wave shield connector shown in FIG. 5. In the second embodiment described below, a component common to the first embodiment is given the same or an equivalent sign and the corresponding description is simplified or omitted.

As shown in FIGS. 5 to 8, an electromagnetic wave shield connector 2 according to the second embodiment of the invention uses as wires two coaxial wires 61 with shield braided wire. A shield terminal 66 made of a conductive metal is attached to each coaxial wire 61 with shield braided wire lead out from the inner housing 20. A shield pipe 62 is crimped with a braided conductor 69 sandwiched between the shield terminal 66 and the shield pipe 62. The shield shell body 65 is assembled via a first rubber plug 63 and a second rubber plug 64. The remaining portions are arranged in the same way as the first embodiment. In FIG. 8, the first and second rubber plugs 63, 64 are not shown for one coaxial wire 61 with shield braided wire.

The first rubber plug 63 is made of an elastically deformable rubber The first rubber plug 63 is formed into a ring shape and attached to the coaxial wire 61 with shield braided wire on the side of the inner housing 20 of the shield pipe 62.

Same as the first rubber plug 63, the second rubber plug 64 is made of an elastically deformable rubber. The second rubber plug 64 is also formed into a ring shape. The second rubber plug 64 is attached to the coaxial wire 61 with shield braided wire on the opposite side of the inner housing 20 of the shield pipe 62.

The electromagnetic wave shield connector 2 is so designed that the shield shell body 65 is assembled via screwing of the bolt 67 to the shield terminal 66 assembled to the lower surface of the outer housing 30 while covering the outer housing 30. By this assembling, the first rubber plug 63 and the second rubber plug 64 are respectively in intimate contact with the inner surfaces of the shield shell body 65 and the shield terminal 66 and the coaxial wire 61 with shield braided wire. The shield terminal 66 crimps the shield pipe 62 with the braided conductor 69 sandwiched between the shield terminal 66 and the shield pipe 62. Thus electric connection between the shield terminal 66 and the braided conductor 69 is established. And also the shield terminal 66 comes into contact with the shield shell body 65 to be electrically connected thereto.

The electromagnetic wave shield connector 2 according to the second embodiment provides the same advantages as the first embodiment. In particular, the electromagnetic wave shield connector 2 according to the second embodiment is so designed that the rubber plugs 63 and 64 are assembled to the coaxial wire 61 with shield braided wire via the shield shell body 65 and the shield terminal 66. It is thus possible to attain water proof of the coaxial wire 61 with shield braided wire, shield shell body 65, shield terminal 66 and inner housing 20.

The invention is not limited to the foregoing embodiments but may be modified or improved as required. The material, shape, dimensions, numeric values, form, count, locations and the like of each component in the foregoing embodiments are arbitrary and not limited as long as the invention is attained.

For example, the number of terminals with electric wire can be four or more as a substitution of that, three or two, shown in Figs. In such a case, the same number of inner housings and the same number of inner housing storing parts of the outer housing as the number of terminals with electric wire are provided.

What is claimed is:

1. An electromagnetic wave shield connector comprising:
an L-shaped terminal for connecting an electric wire including an electric connection part for connecting a counterpart connector and a wire connection part;
an inner housing including a first storing part in which the electric connection part is inserted, and a second storing part in which the wire connection part is accommodated;
an outer housing accommodating the first storing part;
a shield member covering the outer housing assembled with the inner housing; and
a first elastic member mounted on the first storing part so as to come into contact with the first storing portion and the outer housing.

2. The electromagnetic wave shield connector according to claim 1, wherein the first storing part has cylindrical shaped.

3. The electromagnetic wave shield connector according to claim 1, wherein the outer housing has a plurality of openings for accommodating a plurality of the inner housing respectively.

4. The electromagnetic wave shield connector according to claim 1 further comprising;
a second elastic member provided between the counterpart connector and the outer housing.

5. The electromagnetic wave shield connector according to claim 1, wherein the electric connection part and the wire connection part are embedded by resin.

6. The electromagnetic wave shield connector according to claim 1 further comprising;
a rubber plug provided with the wire,
wherein the rubber plug is assembled with the inner housing through the shield member; and
wherein the electric wire is connected to the wire connection part.
